(19) United States
(12) Patent Application Publication
(10) Pub. No.: US 2015/0067671 A1
(43) Pub. Date: Mar. 5, 2015

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: Yuka Kamiya, Machida-shi (JP)

(21) Appl. No.: 14/460,436

(22) Filed: Aug. 15, 2014

(30) Foreign Application Priority Data
Aug. 29, 2013 (JP) 2013-177420

(51) Int. Cl. G06F 9/445; H04N 1/00

(52) U.S. Cl. CPC G06F 8/61; H04N 1/00965; H04N 1/0097; H04N 1/00973
USPC 717/174

(57) ABSTRACT

An information processing apparatus installs, in its own apparatus, of software and setting values corresponding to the software stored in an external storage device in accordance with a script acquired from the external storage device after the external storage device is connected. The information processing apparatus provides an input screen for the setting values when the setting values are not stored in the external storage device upon installation of the setting values according to the script, installs the software by use of the inputted setting values, stores the inputted setting values in the external storage device, and overwrites the script stored in the external storage device so that the stored setting values are referred.

### BACKGROUND OF THE INVENTION

1. Field of the Invention

The present invention relates to an information processing apparatus, a control method thereof, and to a storage medium.

2. Description of the Related Art

When an image forming apparatus is newly installed, it is necessary for a customer side to perform installation operations that depend on their use environment. Generally, the installation operations for an image forming apparatus require a large amount of time and trouble. Therefore, when several image forming apparatus units are installed at the same time, the work load on the personnel performing the installation increases. When the same installation operations can be performed on a plurality of image forming apparatuses, the software, setting values therefor, the verification data, or the like which are required for the use environment can be prepared in advance, and then those materials can be processed according to a script.

Japanese Patent Application Laid-Open No. 2010-224828 discloses a system that sets an execution environment for a plurality of computers, that are the object of the settings, by executing a functional module in accordance with setting values used in the execution environment of the computer. In this manner, automatic and effective installation operations for a computer can be executed.

It is conceived to apply the system disclosed in Japanese Patent Application Laid-Open No. 2010-224828 to an image forming apparatus. However, that system does not consider the installation of a first device (referred to below as “the reference device”) to form the base point for the installations. Since the reference device plays the role of creating data forming a basis for the installation of a second and further device(s) (referred to below as “the clone devices”, all installation operations must be basically performed in a manual configuration.

As disclosed above, installation operations for a reference device can have a partially automatic configuration by preparing in advance software and the like required for the use environment. However, the reference device requires a partially different script or data from the since a manual operation is required for some initial settings on the reference device.

The separation creation of a data set for the single reference device would be extremely cumbersome. Furthermore, the data set to be used must be switched in response to whether a device to be subsequently installed is a reference device or a clone device thereby resulting in an inefficient situation.

### SUMMARY OF THE INVENTION

According to the present invention, an information processing apparatus makes the installation operations of a plurality of information processing apparatuses including a reference device and clone devices more efficient by using a single data set.

According to an aspect of the present invention, an information processing apparatus that is connectable with an external storage device includes an installing unit configured to install, in its own apparatus, software and setting values corresponding to software stored in the external storage device in accordance with a script acquired from the external storage device after the external storage device is connected. The installing unit is configured to provide an input screen for the setting values when the setting values are not stored in the external storage device upon installation of the setting values according to the script, to install the software by using the input setting values, to store the inputted setting values in the external storage device, to store the input setting values in the external storage device, and overwrite the script so that the stored setting valued are referred

Further features of the present invention will become apparent from the following description of exemplary embodiments (with reference to the attached drawings).

### BRIEF DESCRIPTION OF THE DRAWINGS

FIG. 1 illustrates an overall configuration example of an automatic installation system according to the present invention.

FIG. 2 is a block diagram illustrating an example of the principal configuration of an image forming apparatus.

FIG. 3 is a block diagram illustrating a software configuration example of the image forming apparatus.

FIG. 4 illustrates an example of a main menu screen of the image forming apparatus.

FIG. 5 is a block diagram illustrating an example of the software function of the automatic installation program.

FIG. 6 illustrates an example of a folder and file configuration in a USB storage.

FIG. 7 illustrates an example of a script describing an installation sequence of the image forming apparatus.

FIG. 8 illustrates a flowchart of a firmware updating process.

FIG. 9 illustrates a flowchart describing the details of a device configuration import process.

FIG. 10 illustrates a flowchart of an application configuration import process.

FIG. 11A to FIG. 11C illustrate an example of a screen displayed during installation operations for the image forming apparatus.

FIG. 12 illustrates identification information for the image forming apparatus extracted from the script.

FIG. 13 illustrates a flowchart of an import process when a different hardware configuration is detected.

FIG. 14 is a flowchart of the import process in the absence of a parameter.

### DESCRIPTION OF THE EMBODIMENTS

### First Embodiment

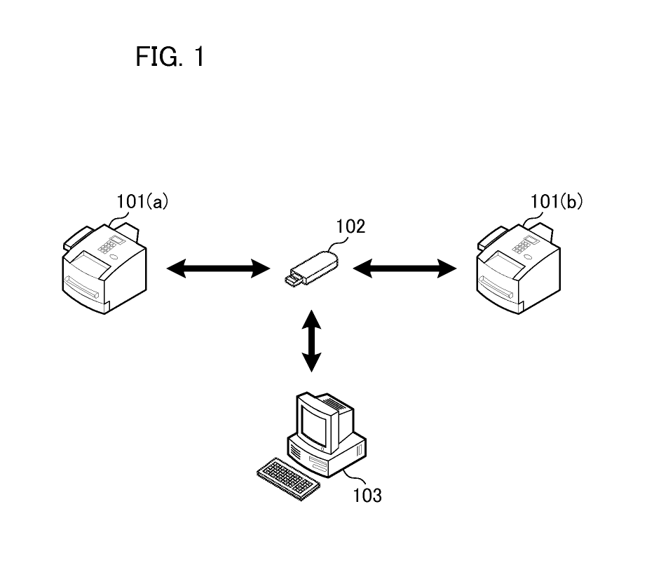

FIG. 1 illustrates an example of a device configuration for an automatic installation system including the image forming apparatus according to the present invention. The automatic installation system of the present invention includes the image forming apparatuses 101(a), (b), a removable storage medium 102 and a client computer 103.

The image forming apparatus 101 is an information processing apparatus integrating a plurality of functions such as scanning, printing, facsimile, and file sending functions in a copying machine. The image forming apparatus 101 includes an interface that connects with the removable storage medium 102. There is no limitation in relation to the type of interface that connects with the removable storage medium 102. However in the present embodiment, a USB interface is used. The connection of the removable storage medium 102 to the interface enables reading and writing of data from/to the removable storage medium 102. The removable storage medium 102 functions as an external storage device, and there is no limitation in relation to the type thereof as long as the device can be simply detached from the apparatus that is configured as the host. However, in the present embodiment, a USB storage 209 is used to mount a USB mass storage class. Furthermore, although FIG. 1 illustrates the provision of a plurality of image forming apparatuses 101(a), 101(b) in the automatic installation system, three or more image forming apparatuses may be provided, or only a single apparatus may be provided. In the following, the system of the present invention will be described with reference to an image forming apparatus 101 that is taken to be representative of the image forming apparatuses 101(a), 101(b).

The client computer 103 is a so-called personal computer. The client computer 103 includes an interface that connects with the removable storage medium 102. Although there is no limitation in relation to the type of the interface that connects with the removable storage medium 102, in the present embodiment, a USB interface is used. The connection of the removable storage medium 102 to the interface enables reading and writing of data from/to the removable storage medium 102. The client computer 103 includes a Web browser program, and can perform various types of settings for the image forming apparatus 101 by accessing a Web site published by a provider company of the image forming apparatus 101.

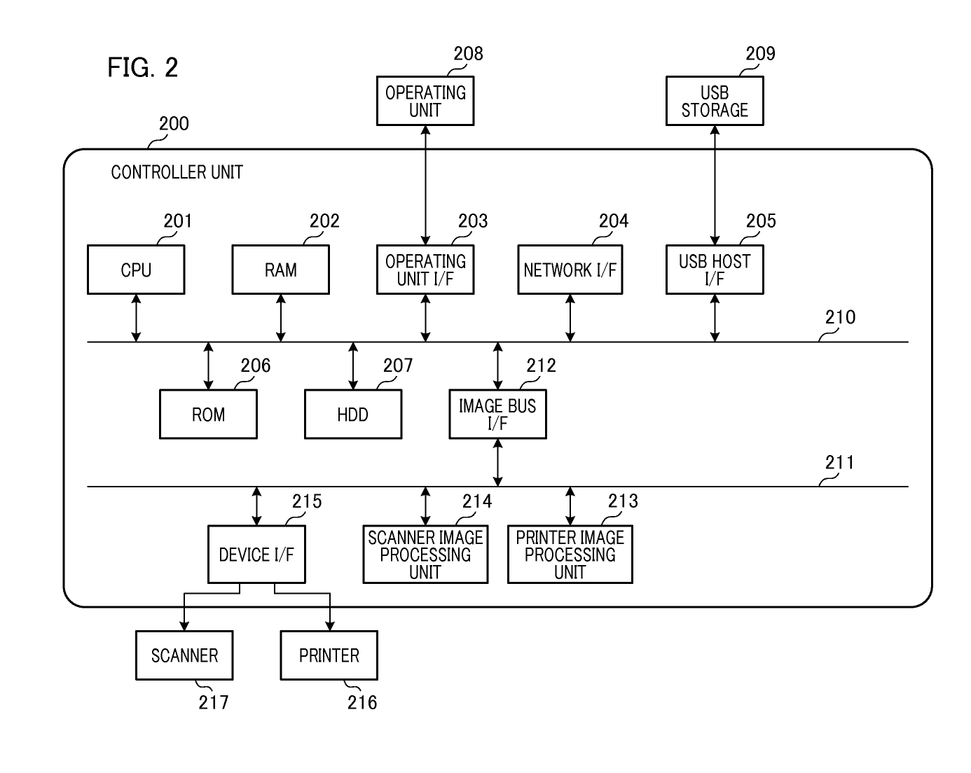

FIG. 2 illustrates a block diagram illustrating an example of the principal configuration of the image forming apparatus 101. The image forming apparatus 101 includes a controller unit 200. The controller unit 200 is connected to a scanner 217 configured as an image input device or a printer 216 configured as an image output device, and is also connected to an operating unit 208 or the USB storage 209. The controller unit 200 performs a control operation to realize copy functions that prints and outputs image data, that is read by the scanner 217, through the printer 216.

The controller unit 200 includes a CPU 201, a RAM 202, an operating unit I/F 203, a network I/F 204, a USB host I/F 205, ROM 206, an HDD 207, and an image bus I/F 212. The controller unit 200 includes a device I/F 215, a printer image processing unit 213, and a scanner image processing unit 214. “CPU” is an abbreviation for a central processing unit. “ROM” is an abbreviation for read only memory. “RAM” is an abbreviation for random access memory. “HDD” is an abbreviation for hard disk drive.

The CPU 201 starts an operation system (OS) by use of a boot program stored in the ROM 206. The CPU 201 uses the OS to execute a program that is stored in the HDD 207, and thereby executes various processing operations. The RAM 202 is used as an operation area for the CPU 201. The RAM 202 provides an operation area, and provides an image memory area for temporary storage of image data. The HDD 207 stores the programs or image data.

The operating unit I/F (operating unit interface) 203 is an interface with the operating unit 208 that includes a touch panel, and outputs, to the operating unit 208, image data to be displayed on the operating unit 208. The operating unit I/F 203 sends information input by a user on the operating unit 208 to the CPU 201. The network I/F (network interface) 204 is an interface for connecting the image forming apparatus 101 to a LAN.

The USB host I/F 205 is an interface unit that communicates with the USB storage 209. The USB host I/F 205 inputs and outputs data stored in the HDD 207 to the USB storage 209. The USB host I/F 205 inputs data stored in the USB storage 209 and sends the same to the CPU 201. The USB storage 209 is an external storage device that, for example, stores a setting file that is imported/exported to/export the image forming apparatus 101, and is attachable/detachable to/from the USB host I/F 205. The USB host I/F 205 can be connected to a plurality of USB devices that includes the USB storage 209.

An image bus I/F 212 is a bus bridge that connects a system bus 210 to an image bus 211 for high-speed transfer of image data, and converts the data format. The image bus 211 is configured by a PCI bus, IEEE 1394, or the like. A device I/F 215, a scanner image processing unit 214, a printer image processing unit 213 are provided on the image bus 211. The CPU 201 to HDD 207 and the image bus I/F 212 are mutually connected through a system bus 210 to send and receive data.

The device I/F 215 is connected to the scanner 217 and the printer 216. The device I/F 215 converts the image data in a synchronous/non-synchronous configuration. The printer image processing unit 213 corrects and performs resolution conversion, or the like on print output image data depending on the printer 216. The scanner image processing unit 214 performs correction, processing and editing in relation to input image data.

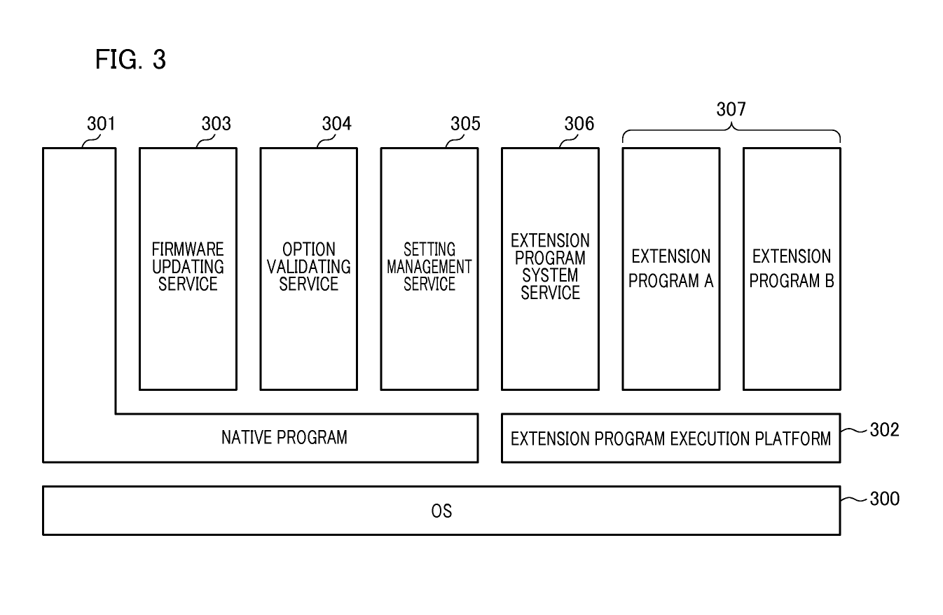

FIG. 3 illustrates an example of a software configuration configured to execute installation operations in relation to the image forming apparatus 101. A native program 301 for control programs that are originally provided for the printer, FAX, scanner or the like, and an extension program execution platform 302 that is the extension program execution platform are operated on the OS 300. Furthermore, a firmware updating service 303, an option validating service 304 and a setting management service 305 are operated on the native program 301. An extension program system service 306 and an extension program 307 operate on the extension program execution platform 302.

The firmware updating service 303 is a service that provides various functions for updating of firmware. For example, the firmware updating service 303 refers to firmware designated by a user and determines whether or not updating of the firmware is required. Firmware is updated either in relation to the native program 301 or through the native program 301.

The option validating service 304 is a service that validates an option function that is incorporated in advance in the native program 301. The option validating service 304 identifies and validates an option function that is specified by an option license file designated by a user.

The setting management service 305 is a service that manages various types of setting information for the printer, the scanner, or the like. When, for example, a user designates a file that includes a plurality of setting information or one or a plurality of settings, the setting management service 305 provides a function of rewriting setting information for the native program 301. The setting management service 305 is provided with a user interface (referred to below as “UI”) and the user can change the setting information through the operating unit 308 of the image forming apparatus 101. Furthermore, the setting management service 305 provides setting information in a file configuration in response to a request from the extension program that is sent through the extension program system service 306. This function is referred to below as export of a device setting information file.

The extension program system service 306 is a utility library that is usefully shared by the extension program 307. Troublesome operations in relation to the development of an extension program can be omitted by calling the function of the extension program system service 306 from the extension program 307.

The extension program 307 can access each module of the image forming apparatus 101 such as the other extension program 307 or the RAM 202 only through the extension program execution platform 302 or the extension program system service 306. The extension program 307 includes a UI, and can display an icon for each extension program on the main menu screen that is displayed on the operating unit 208 of the image forming apparatus 101. When the operating unit I/F 212 detects that the user has selected the icon through the operating unit 208, the operating unit I/F 212 sends the result to the CPU 201. Upon receiving that result, the CPU 201 displays the UI for the extension program selected by the user on the operating unit 208.

The software configuration above only describes the basic features, and the software configuration may include software that provides another service depending on the execution environment. Furthermore, services that are unnecessary due to a reason such as a limitation in the settings or the like may be omitted.

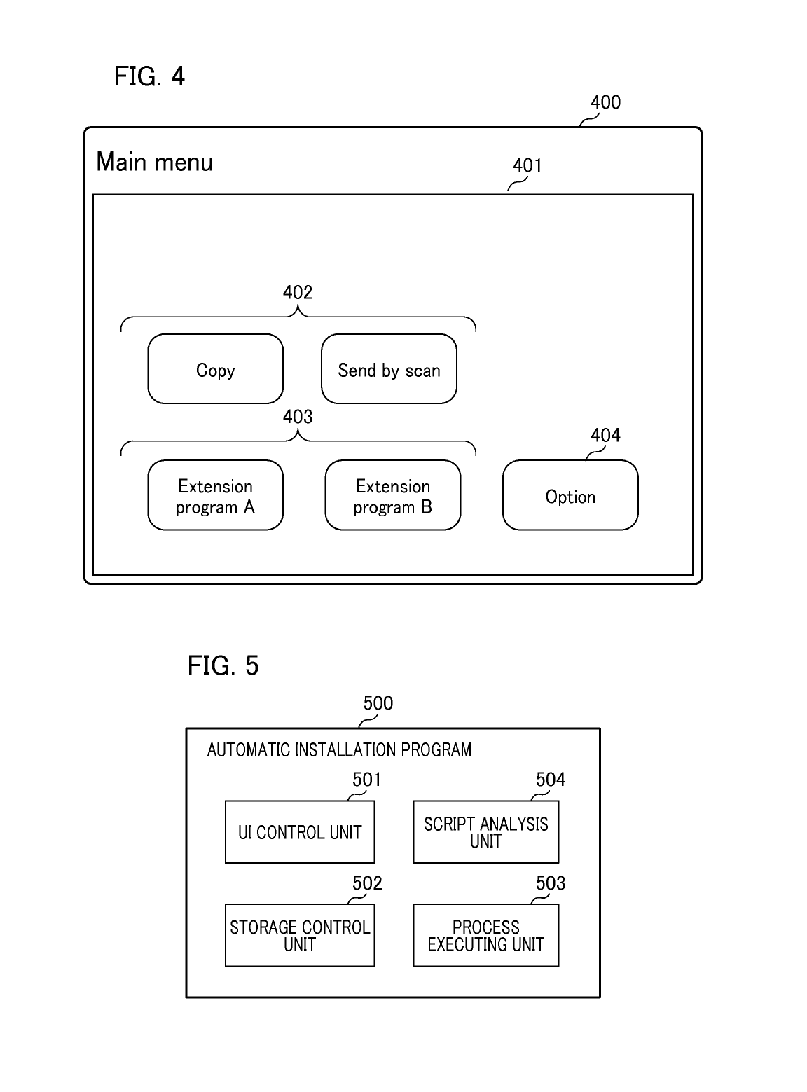

FIG. 4 illustrates an example of a main menu screen that is displayed on the operating unit 208 of the image forming apparatus 101. The main menu screen 400 includes a program icon display area 401, a standard program icon 402, an extension program icon 403, and an option icon 404. The program icon display area 401 is an area for displaying an icon of a program that can currently be operated on the image forming apparatus 101.

The standard program icon 402 is an icon for displaying a UI for execution of functions performed by the control program of the image forming apparatus 101. The extension program icon 403 is an icon configured to display a UI for execution of an extension program of the image forming apparatus 101. The option icon 404 is an icon for displaying a UI for execution of an option function of the image forming apparatus 101.

FIG. 5 illustrates an example of the function configuration of the automatic installation program. The respective functions are realized by the CPU 201 that executes programs corresponding to the respective functions. The automatic installation program 500 includes a UI control unit 501, a storage control unit 502, a process executing unit 503, and a script analysis unit 504.

The UI control unit 501 provides a UI for operating the automatic installation program to the user through the operating unit 208, and receives operations from the user. The storage controller unit 502 performs reading and writing of data of the USB storage 209. The storage controller unit 502 also detects insertion or detachment of the USB storage 209.

The process executing unit 503 performs various processing operations according to commands from the UI control unit 501 and the storage control unit 502. The script analysis unit 504 analyzes the script for installation operation command information that is stored in the USB storage 209, and determines the sequence and processing for execution by the process executing unit 503.

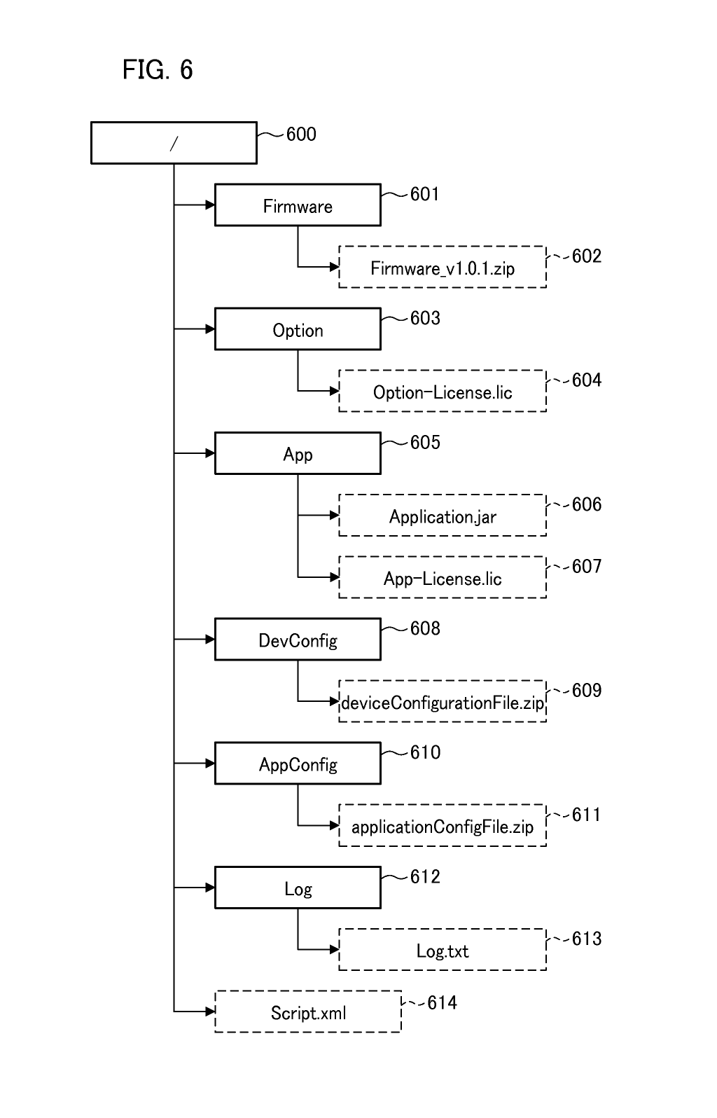

FIG. 6 illustrates an example of a folder and file configuration in the USB storage 209 which are used when the CPU 201 executes automatic installation processing for the image forming apparatus by use of the automatic installation program 500. An internal portion of a route folder 600 stores a Firmware folder 601, an Option folder 603, an App folder 605, a DevConfig folder 608 and an AppConfig folder 610. In addition, the route folder 600 stores a Log folder 612 and a Script.xml file 614.

The Firmware folder 601 is a folder that stores firmware to be updated for the image forming apparatus 101. In the figure, the internal portion of the Firmware folder 601 stores a Firmware_v1.0.1.zip file 602 that archives a firmware group in a zip format.

The Option folder 603 is a folder that stores a license file for validating the option functions that are incorporated in advance in the native program 301. In the figure, the internal portion of the Option folder 603 stores a license file Option-License.lic 604. In the figure, although only one license file is illustrated, when validating a plurality of option functions, a plurality of license files is stored corresponding to each option function.

The App folder 605 is a folder that stores an extension program 307 to be installed on the image forming apparatus 101 and a license file required for installation of the extension program 307. In the figure, an internal portion of the App folder 605 stores an extension program Application.jar 606 and a license file App-License.lic 607. In the figure, although only one extension program and the related license file are illustrated, when installing a plurality of extension programs, a plurality of extension programs and the corresponding license files are stored.

The DevConfig folder 608 is a folder that stores device setting information related to the overall image forming apparatus. In the figure, the internal portion of the DevConfig folder 608 stores a deviceConfigurationFile.zip 609 archived in a zip format.

The AppConfig folder 610 is a folder that stores application setting information related to an extension program 307 that is provided by the Application.jar 606. In the figure, an internal portion of the AppConfig folder 610 stores an applicationConfigFile001.zip 611 archived in a zip format. When there is a plurality of extension programs to be installed, a plurality of corresponding application setting information is stored.

The Log folder 612 is a folder that stores a log file that records the execution results of the automatic installation program 500. In the figure, although Log.txt 613 is stored, prior to execution of the automatic installation program 500, the Log folder 612 and the Log.txt 613 are not present. These folder and file are prepared by the automatic installation program 500 during execution or after execution of the automatic installation program 500.

The Script.xml 614 is a script that describes the installation sequence for automatic processing of the installation operation. The details of the script are described below. The script is a file that defines the installation sequence. However, it may be determined whether or not the automatic installation program 500 is executed by whether or not the script file is present. That is to say, the USB storage 209 during use can be used as an identifier indicating that the USB storage 209 is used in relation to the automatic installation program according to the present invention. The configuration illustrated in the figure is merely exemplary, and the folder can take any arbitrary configuration as long as the CPU 201 can interpret a folder configuration by using the automatic installation program 500 and in accordance with the script 614.

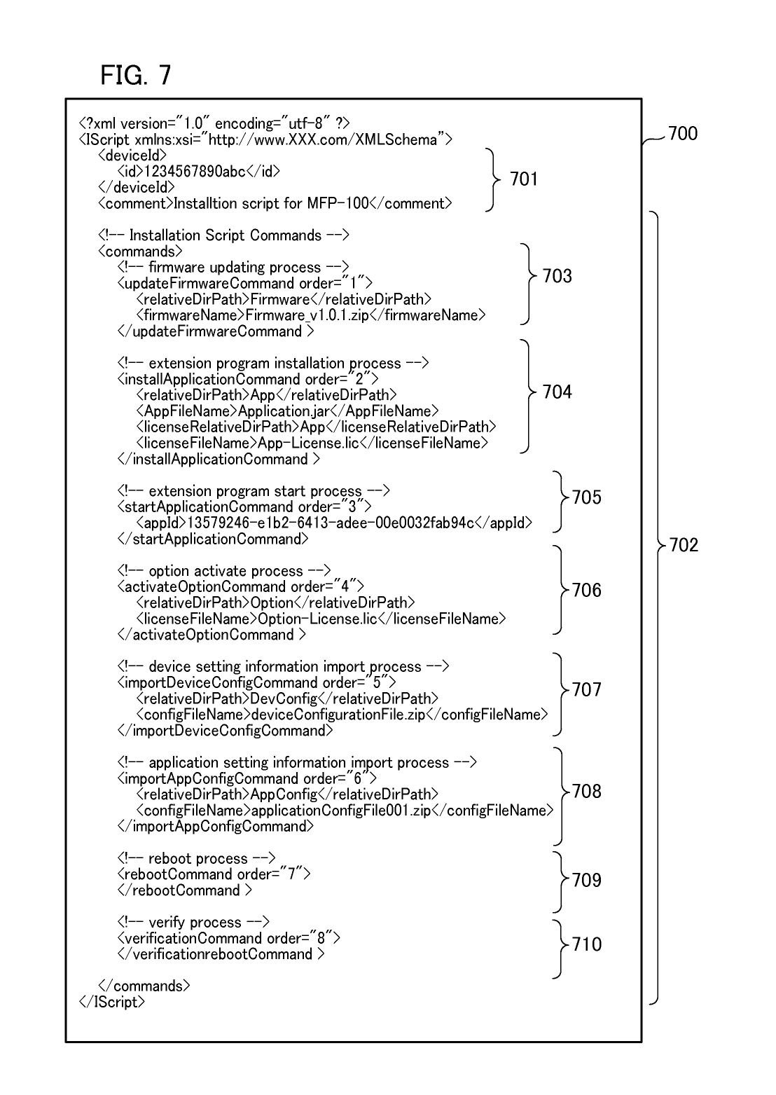

FIG. 7 illustrates an example of Script.xml 614 that describes the installation sequence for automatic processing of the initial installation of the image forming apparatus 101. The script 700 is read by the storage control unit 502 of the automatic installation program 500, and analyzed by the script analysis unit 504 through the process executing unit 503. The script 700 analyzed by the script analysis unit 504 is subsequently executed by the process executing unit 503 as described below. The script 700 in the figure is assumed to be created by the client computer 103. The script 700 is described using extensible markup language (XML), and is configured by an image forming apparatus identifying part 701 and a process describing unit 702. Although the script illustrated in the figure is expressed in XML, there is no particular limitation to XML and description is possible using shell script or the like.

The image forming apparatus identifying part 701 includes information for identifying the image forming apparatus 101 that is the object of the initial installation operation. The image forming apparatus identifying part 701 is configured from a <device Id> that is an identifier for uniquely identifying the image forming apparatus 101 and a <comment> that is any unique character string representing the content of the script. The <comment> does not only describe the content of the script, and may also be used as an identifier when the image forming apparatus cannot be identified only with reference to the <device Id>. Furthermore, the <comment> may be also used as an identifier for each setting when a plurality of settings in addition to installation must be prepared in relation to a single image forming apparatus 101.

The process describing unit 702 describes the processing group required for execution of initial installation. In FIG. 7, the process describing unit 702 is configured by a firmware updating processing part 703, an extension program installation processing part 704, an extension program startup processing part 705, an option-activate processing part 706, and a device setting information import processing part 707. The process describing unit 702 is further configured by an application setting information import processing part 708, a reboot processing part 709, and a verification processing part 710. An Order attribute is included in the tags illustrated in each processing step, and the sequence of the processing steps in the figure is determined by the value of the Order.

Firmware used for updating through the firmware updating service 303 is described in the firmware updating processing part 703. The firmware updating processing part 703 defines a process by describing an <updateFirmwareCommand> tag, and designating a file that is used by a <relativeDirPath> tag and a <FirmwareName> tag. The <relativeDirPath> tag describes a relative path from the route folder 700 to the firmware to be updated. The <FirmwareName> tag designates the firmware to be updated. In the example shown in FIG. 7 firmware that is archived in a Zip format is designated.

The extension program installation processing part 704 defines processing with the description in an <installApplicationCommand> tag. A <relativeDirPath> tag and An <AppFileName> tag designate the extension program to be installed. The <relativeDirPath> tag describes a relative path from the route folder 700 to the extension program entity to be installed. The <AppFileName> tag designates the entity for the extension program to be installed. In the example illustrated in FIG. 7, an extension program in a Jar file format is designated. However, the format of the extension program is not limited to the Jar file format.

The license for the extension program to be installed is designated by a <licenseRelativeDirPath> tag and a <licenseFileName> tag. The <licenseRelativeDirPath> tag describes a relative path from the route folder 700 to the license file for the extension program. The <licenseFileName> tag designates the entity for the extension program. In the example illustrated in FIG. 7, a license file in a lic file format is designated. However, the format of the license file is not limited to the lic file format.

The extension program startup processing part 705 defines processing by the description in a <startApplicationCommand> tag. An <appId> tag designates the extension program for startup. The <appId> tag designates the ID that uniquely identifies the extension program for startup.

The option-activate processing part 706 defines processing by the description in an <activeOptionCommand> tag. A <relativeDirPath> tag and A <licenseFileName> tag designate the license file for the option that is to be activated. The <relativeDirPath> tag describes a relative path from the route folder 700 to the license file for the option that is to be activated. In the example illustrated in FIG. 7, although the license file is designated in the lic file format, there is no limitation to the file format of the license. When the option function is not incorporated in advance into the image forming apparatus 101, or when it is not valid, the description of this process is not required.

The device setting information import processing part 707 defines processing by the description in an <importDeviceConfigCommand> tag. a <relativeDirPath> tag and a <configFileName> tag designate the device setting information file to be imported. The <relativeDirPath> tag describes a relative path from the route folder 700 to the device setting information file to be imported. The <configFileName> tag designates the device setting information file to be imported. In the example illustrated in FIG. 7, although a device setting information file that is archived in a Zip format is designated, the format of the device setting information file is not limited to the Zip format.

The application setting information import processing part 708 defines processing by the description in an <importAppConfigCommand> tag. A <relativeDirPath> tag and a <configFileName> tag designate the application setting information file to be imported. The <relativeDirPath> tag describes a relative path from the route folder 700 to the device setting information file to be imported. The <configFileName> tag designates the application setting information file to be imported. In the example illustrated in FIG. 7, although the application setting information file that is archived in a Zip format is designated, the format of the application setting information file is not limited to the Zip format.

The reboot processing part 709 is configured only by a <rebootCommand> tag, and the processing unit for causing the image forming apparatus to reboot and to reflect the setting on the image forming apparatus after completion of a series of installation processing operations.

The verification processing part 710 is configured only by a <verificationCommand> tag. The verification processing part 710 describes a process of verifying whether setting information installed based on the information described in the device or application setting information import processing parts 707, 708 matches setting information for the image forming apparatus after rebooting. The script description illustrated in the figure is not limited to the processing operations that are required for installation of the image forming apparatus, and may include a reduction/increase or overlapping of processing operations as required.

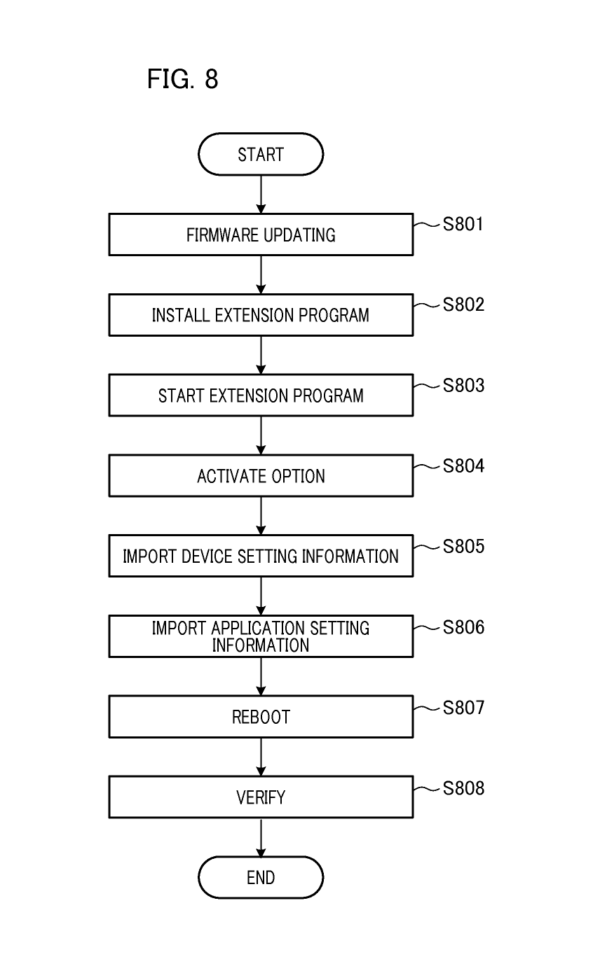

FIG. 8 illustrates a flowchart describing the flow of the installation process executed by the CPU 201 in accordance with the script 700 and by use of the automatic installation program 500. In step S801, the process executing unit 503 executes the updating process using the updating firmware as a result of the script analysis unit 504 analyzing the firmware updating processing part 703 of the script 700. In step S802, the process executing unit 503 installs the extension program as a result of the script analysis unit 504 analyzing the extension program installation processing part 704 of the script 700. In step S803, the process executing unit 503 starts the extension application as a result of the script analysis unit 504 analyzing the extension program startup processing part 705 of the script 700. In step S804, the process executing unit 503 activates an option as a result of the script analysis unit 504 analyzing the option-activate processing part 706 of the script 700.

In step 805, the process executing unit 503 installs the device setting information as a result of the script analysis unit 504 analyzing the setting information import processing part 707 of the script 700. In step 806, the process executing unit 503 imports the application setting information as a result of the script analysis unit 504 analyzing the application setting information import processing part 707 of the script 700. Steps from 801 to 804 and steps 807 and 808 may be automatized in the case of the installation of the reference device. More specifically, firmware, an extension program, a license file for an extension program, and an option license file may be prepared in advance in the USB storage 209.

However, the import of the device setting information in step 805 and the import of the application setting information in step 806 firstly require an operation in which that setting information is recorded on the reference device by installation personnel to thereby create an import file. The respective import processing parts 707, 708 for the script 700 that correspond to the processing in steps 805 and 806 are not required when installing the reference device, and represent the feature of difference when installing the clone devices.

In step S807, the process executing unit 503 executes the reboot process as a result of the script analysis unit 504 analyzing the reboot processing part 709 of the script 700. In step S808, the process executing unit 503 executes verification as a result of the script analysis unit 504 analyzing the verification processing part 710 of the script 700.

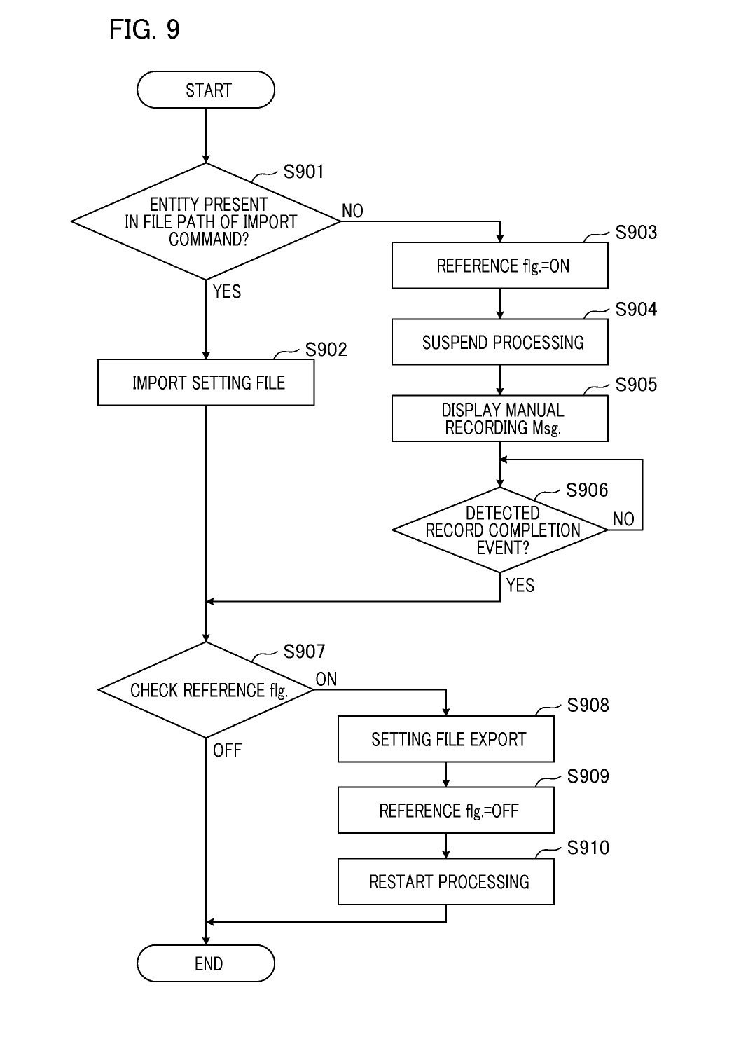

Next, the method for realizing installation of the reference device and installation of the clone devices using the same script will be described with reference to FIG. 9. FIG. 9 illustrates a flowchart describing the details of a device setting information import process in step 805 in relation to the flowchart in FIG. 8.

In step 901, the storage control unit 502 refers to the USB storage 209 based on the device setting information import processing part 707 that has been read by the script analysis unit 504. More specifically, the storage control unit 502 refers to the USB storage 209 based on the device settings information file name <configFileName> and the relative path indicating the storage location of the device settings information file <relativeDirPath>. The storage control unit 502 checks whether or not the device setting information file of the above file name is present in the folder indicated by the above path. When the device setting information file is present, the storage control unit 502 determines that its own apparatus is an apparatus that reflects the setting values. In step 902, the storage control unit 502 stores the device setting information file in the HDD 207 of device. The process executing unit 503 imports the device setting information file through the setting management service 305.

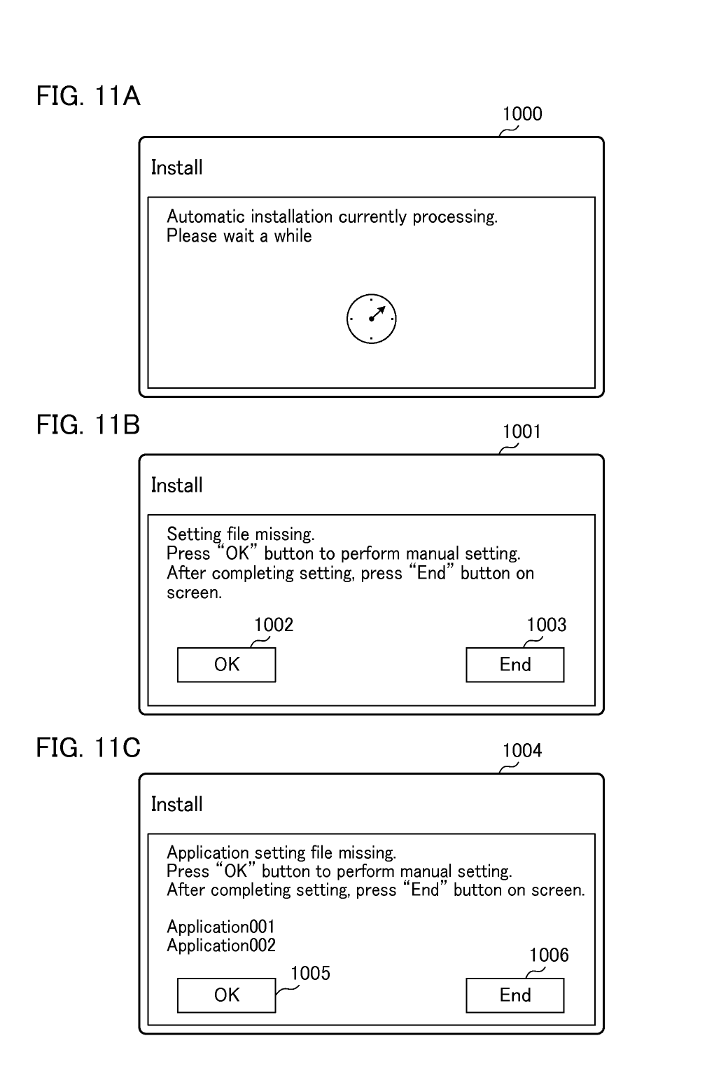

A screen as illustrated in FIG. 11A is displayed on the operating unit 208 at this time. This screen is displayed when the automatic installation process is started by the automatic installation program 500. It is naturally the case that the same screen is not required from startup, and it may be configured to display the current processing that is executed in each step from step 801 to 808 that is displayed in the series of processing illustrated in FIG. 8.

In step 901, when the device setting information file is absent, the storage control unit 502 determines that its own apparatus is the reference apparatus that is referred to by another apparatus. In step 903, the process executing unit 503 places an internal flag for showing that the object of the current installation process is the reference device (reference apparatus) in the ON position. In the following description, this internal flag is referred to as the reference flag. In step 904, the process executing unit 503 temporarily suspends the processing of the script 700.

In step 905, the UI control unit 501 displays a screen illustrated in FIG. 11B through the operating unit I/F 203 on the operating unit 208. The screen in FIG. 11B indicates to a user that the device setting information file is incomplete (that is to say, the installation operation for the reference device is currently being performed), and prompts manual recording of the device setting information.

The device setting information related to the overall image forming apparatus includes setting information for service personnel (referred to below as service mode), and setting information that can be set by an end user (referred to below as user mode), different setting screens for the respective information is provided. In the present embodiment, although the two types of setting information are assumed, there is no limitation to those two types of setting information, and naturally more numerous setting information may be present depending on the image forming apparatus, or only one type of setting information may be present.

When a user depresses the OK button 1002 in FIG. 11B and when receiving a key event from the operating unit I/F 203, the UI control unit 501 requests the operating unit I/F 203 to display the input screen for service mode settings. The operating unit I/F 203 displays the setting screen for service mode on the operating unit 208 in response to the request.

When the user completes the service mode settings and when receiving a close event for the service mode screen from the operating unit 208, the operating I/F 203 notifies that fact to the UI control unit 501. After receiving that event, the UI control unit 501 requests the operating unit I/F 203 to display the input screen for user mode settings. The operating unit I/F 203 displays the setting screen for user mode on the operating unit 208 in response to the request.

When the user completes the user mode settings and when receiving the close event for the user mode screen from the operating unit 208, the operating I/F 203 notifies that fact to the UI control unit 501. The UI control unit 501 after receiving that event re-performs the display of the screen in FIG. 11B.

In step 906, the UI control unit 501 receives a pressing event of the “end” button 1003, and the process executing unit 503 checks configuration state of the reference flag (step 907). When the device setting information file is present, it is determined that the object to be installed is a clone device, and the processing proceeds to step 902. After importing of the device setting information file in step 902 is completed, the process executing unit 503 checks the state of the reference flag. When the reference flag indicates OFF, the process executing unit 503 shifts to the process described in the application setting information import processing part 708 of the script.

When the reference flag indicates ON, the process executing unit 503 creates the device setting information file in the HDD 207, and the storage control unit 502 exports the device setting information file to the USB storage 209 (step 908). The device setting information file is the file name that is described in the device setting information import processing part 707 of the script 700, and is exported to the folder indicated by the described path.

In step 909, the process executing unit 503 releases (places in OFF position) the reference flag, and restarts the process from the application setting information import processing part 708 of the script 700 in step 910. In the description above, the information processing apparatus according to the present invention can make installation operations for a plurality of information processing apparatuses including a reference device and clone devices more efficient by using a single data set. More specifically, as described above, when a device setting information file is not present in the path described by device setting information import processing part 707 of the script 700, it is determined to be installation of a reference device. Then, the process executing unit 503 causes a user to perform manual recording of the device setting information, and switches the process to the process to export the device setting information file to thereby enable automatic installation of setting values with the same script 700 for both the reference device and clone devices.

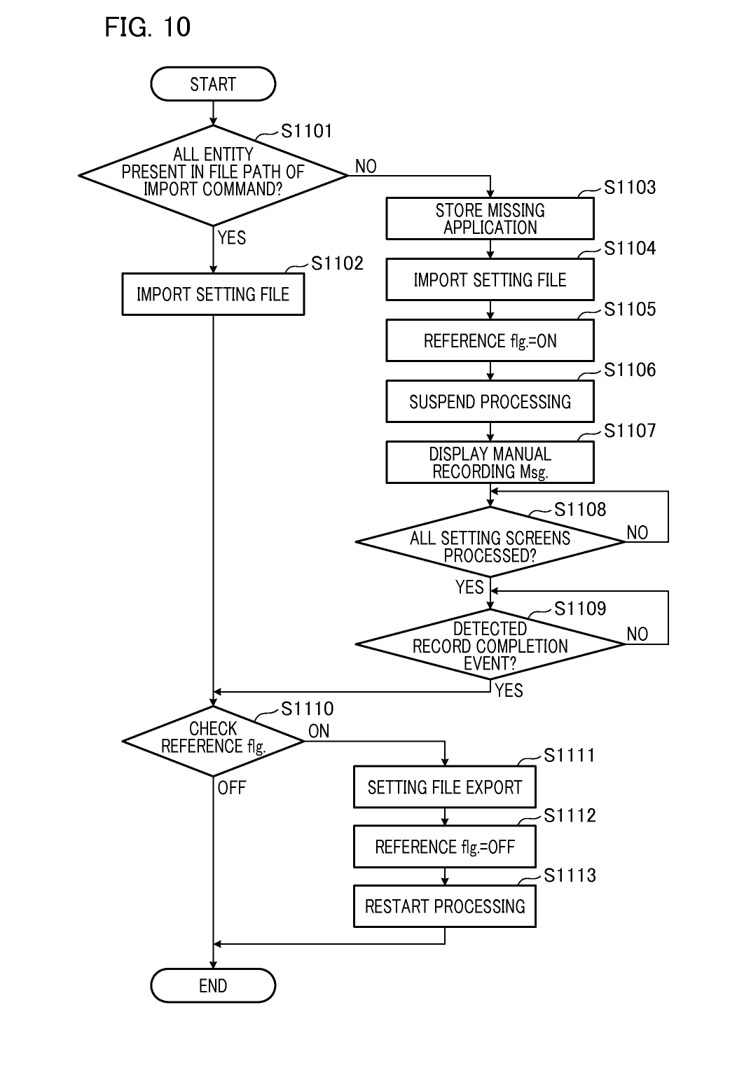

FIG. 10 illustrates a flowchart that describes the details of an application configuration import process in step 806 in the flowchart illustrated in FIG. 8. In this context, it is assumed that a plurality of application setting information files is handled. A description is given of a flow of processing in which the application settings in the installation of the reference device and the clone devices are also realized by use of with the same script.

Although only a single application setting information file is described in the application setting information import processing part 708 illustrated in FIG. 7, when a plurality of those files is present, a plurality of <configFileName> tags may be described.

In step 1101, the storage control unit 502 refers to the USB storage 209 based on the information that has been read by the script analysis unit 504. The information that has been read is the application settings information file name <configFileName> and the relative path <relativeDirPath> that indicates the storage location of the application settings information file of the application settings information import processing part 708. The storage control unit 502 checks whether or not all the application setting information files designated using the <configFileName> tag are present in the folder indicated by the above path. When all the application setting information files are confirmed to be present, the storage control unit 502 determines that it is a device that reflects the setting values. In step 1102, the storage control unit 502 stores all the application setting information files in the HDD 207 of the device. The process executing unit 503 imports the application setting information file through the extension program system service 306.

A screen as illustrated in FIG. 11A is displayed on the operating unit 208 at this time. This screen is displayed when the automatic installation process is started by the automatic installation program 500. It is naturally the case that the same screen is not required from startup, a configuration may be display the current processing operation that is executed in each step from step 801 to 808 that is displayed in the series of processing operations illustrated in FIG. 8.

In step 1101, when a part or all of the application setting information files are not present, the storage control unit 502 determines that its own device is the reference device that will be referred to by another apparatus. In step 1103, the process executing unit 503 stores, in the RAM 202, an identifier that can specify the extension program such as an ID or name of the extension program in which an application setting information file is not present. Therefore, the application setting information file name that is described in the application setting information import processing part 708 in FIG. 7 must be a file name that can specify a corresponding extension program. A means such as a table that illustrates the correspondences between the application setting information file names and the IDs or names of the extension files may be provided by storage in advance in the automatic setting program 500.

In step 1104, the process executing unit 503 imports all the application setting information files partially present in the USB storage 209 through the extension program system service 306. In the event where therein no application setting information file is present, the step 1104 is skipped. In step 1105, the reference flag that indicates that the current installation process is concerned with the reference device is set to ON, and the processing of the script 700 is temporarily suspended (step 1104).

In step 1107, the UI control unit 501 displays the screen illustrated in FIG. 11C on the operating unit 208 through the operating unit I/F 203. The screen in FIG. 11C indicates to a user that the application setting information file is missing (that is to say, the installation operation for the reference device is currently being performed), and prompts manual recording of the device setting information. At this time, the extension program name that is missing from the application setting information file may be displayed.

When a user depresses the OK button 1002 in FIG. 11C and when receiving a key event from the operating unit I/F 203, the processing proceeds to step 1108. In step 1108, the UI control unit 501 requests the operating unit I/F 203 to display the application setting screen for the first extension program. The first extension program is one of the applications that are missing from the application setting information file stored in the RAM 202 in step 1103. In the present embodiment, it is assumed to be extension program A. There is no requirement for a particularly determined configuration in relation to a rule for the sequence of displaying the application setting screen. The operating unit I/F 203 displays the application setting screen for extension program A on the operating unit 208 in response to the request.

When the user completes the recording of the application setting information for extension program A and when receiving a close event for the application setting screen for extension program A from the operating unit 208, the operating I/F 203 notifies that fact to the UI control unit 501. The process executing unit 503 deletes the record related to extension program A from the RAM 202. In this manner, with respect to the application setting screen for extension program stored in the RAM 202, the process executing unit 503 repeats a process of open, close and deletion of the record related to extension program from the RAM 202. When processing on all application setting screens is completed, the UI control unit 501 performs re-display of the screen in FIG. 11C.

In step 1109, when the UI control unit 501 receives a pressing event of the “end” button 1006, and the process executing unit 503 checks the state of the reference flag (step 1110). When all the application setting information files are present in step 1110, import of the application setting information files is completed (step 1102), and the state of the reference flag is checked. When the reference flag is set to OFF, the process executing unit 503 proceeds the processing to the reboot processing part 709 of the script 700.

When the reference flag is set to ON, the process executing unit 503 creates the application setting information file in the HDD 207, and the storage control unit 502 exports the application setting information file to the USB storage 209 (step 1111). The application setting information file is the file name that is described in the application setting information import processing part 708 of the script 700, and is exported to the folder indicated by the described path. In step 1112, the process executing unit 503 sets the reference flag to OFF, and restarts the processing from the reboot processing part 709 of the script 700 in step 1113.

In the description above, when only a part or all of the application setting information files are not present in the path described in the application setting information import processing part 708 of the script 700, it is determined that the device is the reference device. Therefore, a user is caused to manually record the application setting information for each extension program, and then the processing switches to export the application setting information files. As a result, automatic installation with the same script 700 is enabled for both the reference device and the clone devices.

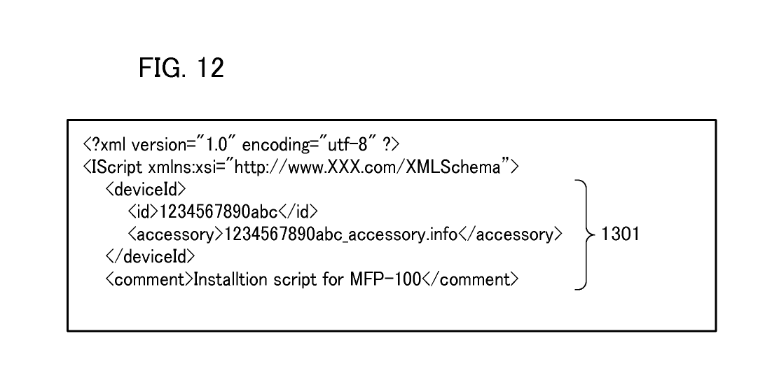

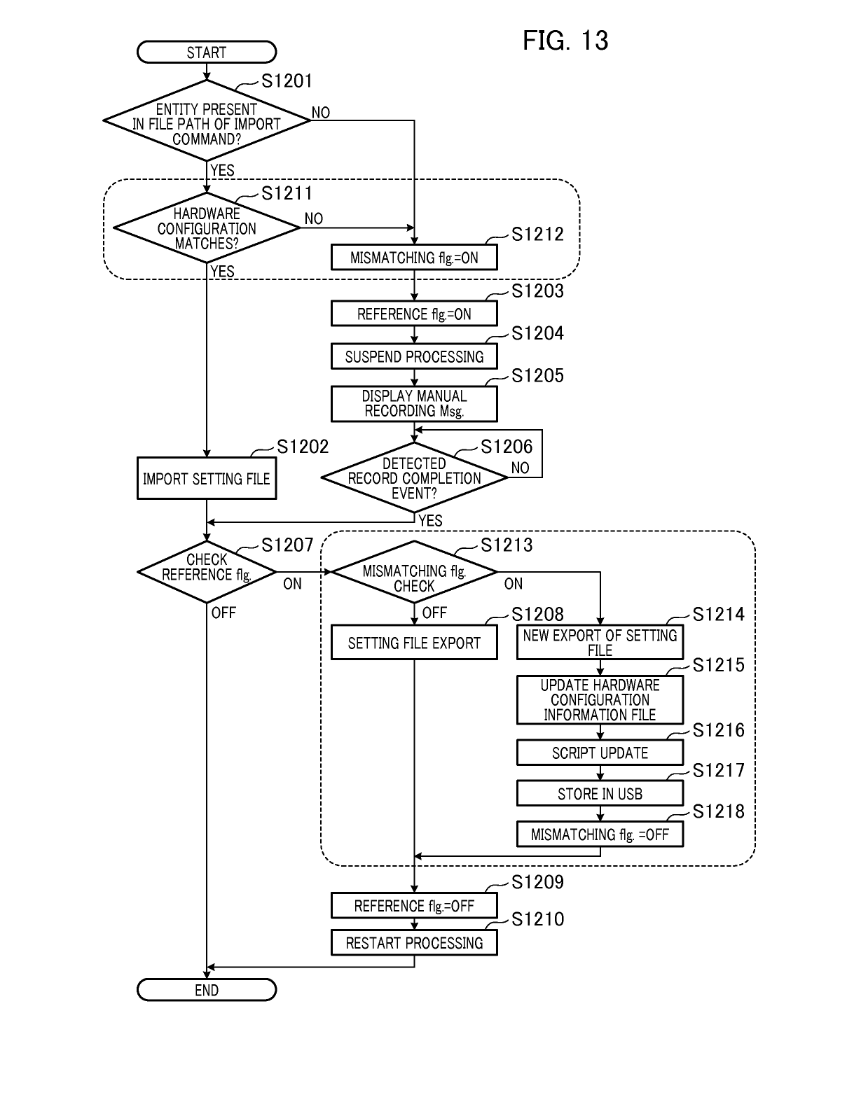

In the processing described making reference to FIG. 9, even in the event that the required device setting information file is present in the USB storage 209, there is the case to be determined that the device is the reference device. This is due to the fact that there is a difference between the hardware configuration information that is referred to from the script 700 and the actual hardware configuration of the image forming apparatus that is the object of automatic installation. This feature will be described below with reference to FIG. 12 and FIG. 13.

FIG. 12 illustrates extraction of the image forming apparatus identifying part 701 from the script 700. In addition to the image forming apparatus identifying part 701, it can be seen that an <accessory> tag is added. This tag describes the file name of the hardware configuration information file (not illustrated) that records the original hardware configuration information for the image forming apparatus that is to be installed. The hardware configuration information is a list of hardware components mounted as an option in the image forming apparatus that is the basic unit, and enables comprehension of which options are mounted in each image forming apparatus.

There is no particular limitation of a description rule for or the format of the hardware configuration information file. Any format may be employed as long as the CPU 201 can analyze the automatic installation program 500. In the present embodiment, although the hardware configuration information file is created separately, a configuration is possible in which an identifier that enables identification of each hardware option is directly described in the image forming apparatus identifying part 701 of installation of the script 700. The hardware configuration information for the image forming apparatus that is specified by an <id> is recorded in the hardware configuration information file.

FIG. 13 illustrates a flowchart describing the flow of processing when executing automatic installation processing in relation to an image forming apparatus having a different hardware configuration. Since step 1201 to step 1210 are the same as step 901 to 910 of FIG. 9 that describe the flow of import processing for the device setting information file, such description is omitted. Only the processing in step 1200 to step 1218 that are the points of difference will be described.

When the storage control unit 502 confirms the presence of a device setting information file in step 1201, the process executing unit 503, in step 1211, acquires hardware configuration information for the image forming apparatus through the extension program system service 306. The process executing unit 503 compares the acquired hardware configuration information with the hardware configuration information described in the hardware configuration information file in the HDD 207. When the hardware configuration information matches, the process executing unit 503 determines that the device setting information file in the USB storage 209 is valid. In step 1202, the storage control unit 502 copies the hardware configuration information file of the USB storage 209 into the HDD 207. The process executing unit 503 executes importing of the device setting information file.

In step 1211, when the hardware configuration information does not match, the process executing unit 503 sets the hardware configuration information mismatching flag (referred to below as the mismatching flag) to ON. The mismatching flag is an internal flag that indicates that there is no matching between the hardware configuration information file and the hardware configuration information for the image forming apparatus that is the current object of installation.

Thereafter, in the step 1203, the process executing unit 503 sets the reference flag to ON, and executes processing of the installation object as the reference device (step 1204 to step 1207). When the hardware configuration information does not match, since the setting items related to the hardware are varied, there is a high possibility that the current device setting information file that is stored in the USB storage 209 will not be suitable. Therefore, it is necessary to process the installation object as the reference device.

In the step 1207, when the reference flag is ON, the process executing unit 503 checks the state of the mismatching flag in step 1213. When the mismatching flag is set to OFF, in the same manner as a normal reference device, in step 1208, exporting of the device setting information file is executed. When the mismatching flag is set to ON, the process executing unit 503, in step 1214, executes exporting using a file name that is different to the file name described in the device setting information import processing part 707 of the script 700.

The process executing unit 503, in step 1215, updates the hardware configuration information files based on the actual hardware configuration information. In step 1216, the script analysis unit 504 updates the device setting information import processing part 707 of the script that is originally present in the USB storage 209, and newly updates the file name using the exported device setting information file. The storage control unit 502, in step 1217, stores the updated script in the USB storage 209. After updating and new creation of the various files, and storage of those files in the USB storage, in step 1216, the process executing unit 502 sets the mismatching flag to OFF.

In the present embodiment, the device setting information file is newly created, and the hardware configuration information file and the script are updated. However, there is no limitation in this regard. A file that is prepared separately for the image forming apparatus that is the object of installation may be updated, and a file that may be possibly shared with another unit may be newly created as well as remaining the original file. For example, a device setting information file that is added to the original device setting information file and newly exported is updated. In this manner, a new device setting information file and the original device setting information file can be used in the installation of another image forming apparatus. In that case, in the processing of Step 1211, the determination processing is performed as to whether hard ware configuration of the image forming apparatus to be newly installed matches the newly exported hardware configuration or the initially described hardware configuration. When this configuration is applied, if the hardware configuration does not match, the device setting information file is added and updated at that point. As described above, it is possible to prevent import of an erroneous device setting information file by checking the hardware configuration information.

### Second Embodiment

In the first embodiment, when a device setting information file for import of the described file name or an application setting information file is not present in the file path described in the script 700, it is determined that the device is the reference device. Separately, when both the file path and the file name are not described in the script 700, it is determined that the device is the reference device.

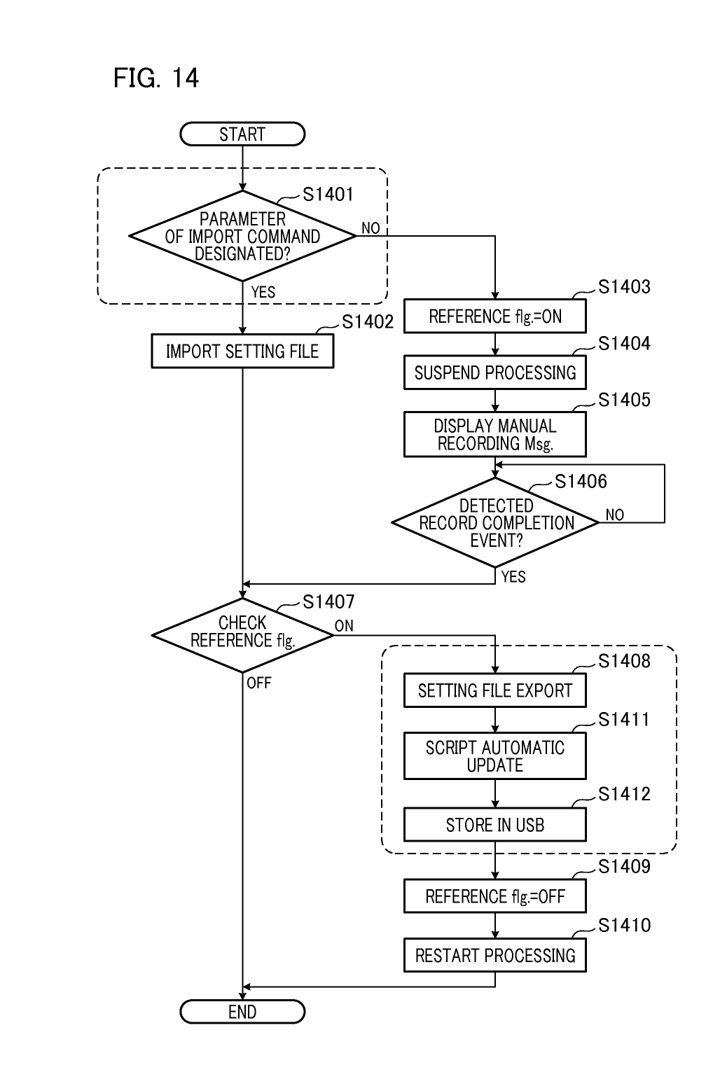

FIG. 14 is a flowchart describing the flow of the processing when both the file path and file name for a device setting information file for import into the script 700 are not described. That is to say, it is assumed that <relative DirPath> and <configFileName> of the device setting information import processing part 707 of the script 700 are not described. Since step 1402 to step 1407, and step 1409 and step 1410 are the same as step 902 to step 907, and step 909 to step 910 in FIG. 9 of the first embodiment, the present embodiment will only describe the different aspects of processing.

In step 1401, the script analysis unit 504 determines whether a parameter for the import command is described. More specifically, the script analysis unit 504 checks whether or not the <relativeDirPath> tag and <configFileName> tag are described in the device setting information import processing part 707. Furthermore, the script analysis unit 504 checks whether or not those values (file path, file name) are described. When they are described, the process executing unit 503, in step 1402, determines that its own apparatus is a clone device, and executes import of the device setting information file as a normal installation process. When they are not described, a shift in the processing to the installation object as a reference device occurs, and the processing after step 1403 is executed.

When the reference flag in step 1407 is in ON, the process executing unit 503 exports the device setting information file in step 1408. The file name of the device setting information file exported at this time may be created in accordance with a rule that is predetermined in the automatic installation program 500, or the export file name that is provided by the setting management service may be used without modification.

In step 1411, the script analysis unit 504 updates the device setting information import processing part 707 that is originally present in the USB storage 209. More specifically, the file name of the exported device setting information file and the description of the file path that is predetermined by the automatic installation program 500 are added.

The storage control unit 502, in step 1412, stores the exported device setting information file and the updated script in the USB storage 209. When storage in the USB is completed, the process executing unit 503 sets the reference flag to OFF in step 1409.

The configuration described above enables an installation operation using the same script in relation to both the reference device and the clone devices even when a parameter for the import command is not described, and thereby further enhances efficiency.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-177420, filed Aug. 29, 2013 which is hereby incorporated by reference herein in its entirety.

What is claimed is:

1. An information processing apparatus that is connectable with an external storage device, comprising:
an installing unit configured to install, in its own apparatus, software and setting values corresponding to software stored in the external storage device in accordance with a script acquired from the external storage device after the external storage device is connected,
wherein the installing unit is configured to provide an input screen for the setting values when the setting values are not stored in the external storage device upon installation of the setting values according to the script, to install the software by using the input setting values, to store the inputted setting values in the external storage device, to store the input setting values in the external storage device, and overwrite the script so that the stored setting valued are referred.

2. The information processing apparatus according to claim 1, wherein, when the setting values are not stored in the external storage device upon installation of the setting values according to the script, the installing unit determines that its own apparatus is a reference apparatus that is referred to by another apparatus so as to provide the input screen for the setting values, and
when the setting values are installed in the external storage device, the installing unit determines that its own apparatus is a reflecting apparatus that reflects the setting values that are installed by the reference apparatus, and installs the software and the setting values corresponding to the software that is stored in the external storage device in its own apparatus.

3. The information processing apparatus according to claim 2, wherein the installing unit determines that its own apparatus is the reference apparatus that is referred to by another apparatus when the script has no description of setting values for device setting information for the information processing apparatus, setting values for all application setting information, or parameters for an import command.

4. The information processing apparatus according to claim 3, wherein, when the setting values are stored in the external storage device, the installing unit further determines whether or not the device setting information described in the script matches device setting information installed in its own apparatus, and when the information does not match, adds device setting information installed in its own apparatus to the device setting information described in the script, or updates the script by using the device setting information installed in its own apparatus and stores it in the external storage device.

5. The information processing apparatus according to claim 1, wherein, when the setting values are not stored in the external storage device upon installation of the setting values according to the script, the installing unit provides the input screen after setting a flag, and releases the flag after storing the script, that has been rewritten using the inputted setting values, in the external storage device.

6. A control method of an information processing apparatus that is connectable with an external storage device, comprising:
installing, in its own apparatus, software and setting values corresponding to software stored in the external storage device in accordance with a script acquired from the external storage device after the external storage device is connected,
wherein in the installing step, an input screen for the setting values is provided when the setting values are not stored in the external storage device upon installation of the setting value according to the script, the software is installed by using the input setting values, the input setting values are stored in the external storage device, and the script stored in the external storage device is overwritten so that the stored setting values are referred.

7. A non-transitory storage medium on which is stored a computer program for making a computer execute a control method of an information processing that is connectable with an external storage device, comprising:
installing, in its own apparatus, software and setting values corresponding to software stored in the external storage device in accordance with a script acquired from the external storage device after the external storage device is connected,
wherein in the installing step, an input screen for the setting values is provided when the setting values are not stored in the external storage device upon installation of the setting value according to the script, the software is installed by using the input setting values, the input setting values are stored in the external storage device, and the script stored in the external storage device is overwritten so that the stored setting values are referred.
